(19) United States
(12) Patent Application Publication
(10) Pub. No.: US 2014/0115349 A1
(43) Pub. Date: Apr. 24, 2014

(54) COMPUTER APPARATUS AND WAKE-UP METHOD THEREOF

(71) Applicants: INVENTEC (PUDONG) TECHNOLOGY CORPORATION, Shanghai (CN); INVENTEC CORPORATION, Taipei (TW)

(72) Inventors: Chih-Ming Chen, Taipei (TW); Chian-Ting Chen, Taipei (TW); Wen-Tai Liu, Taipei (TW)

(73) Assignees: INVENTEC CORPORATION, Taipei (TW); INVENTEC (PUDONG) TECHNOLOGY CORPORATION, Shanghai (CN)

(21) Appl. No.: 13/791,269

(22) Filed: Mar. 8, 2013

(30) Foreign Application Priority Data
Oct. 24, 2012 (CN) 201210410040.4

(51) Int. Cl. G06F 1/26

(52) U.S. Cl. CPC G06F 1/26
USPC 713/300

(57) ABSTRACT

The disclosure provides a computer apparatus including a peripheral device, a hub unit and a control unit, and a wake-up method thereof. The peripheral device is configured to generate an input signal. The hub unit is coupled to the peripheral device. When the computer apparatus is in a power-saving state, the hub unit is configured to receive the input signal to generate a wake-up event (WUE). The control unit is coupled to the hub unit. When the computer apparatus is in the power-saving state, the control unit is configured to detect whether the WUE is generated, so as to wake up the computer apparatus, so that the computer apparatus is returned to a normal operating state from the power-saving state.

### CROSS-REFERENCE TO RELATED APPLICATIONS

This non-provisional application claims priority under 35 U.S.C. §119(a) on Patent Application No(s). 201210410040.4 filed in China on Oct. 24, 2012, the entire contents of which are hereby incorporated by reference.

### BACKGROUND OF THE INVENTION

1. Field of the Invention

The disclosure relates to a control technology for a computer apparatus, and more particularly to a computer apparatus being wakened through a peripheral device, and a wake-up method thereof.

2. Description of the Related Art

Most of the current computer apparatuses support a power-saving mechanism or a sleep function, so as to save power consumption. A computer apparatus implemented by using X86 architecture generally sets break mechanisms for power-saving and sleeping states and a function for waking up the computer apparatus from three states in a central processing unit (CPU) and a corresponding chip set, for example, a CPU of X86 architecture and a chip set thereof manufactured by the Intel company or Advanced Micro Devices (AMD) company.

For example, when a user intends to use the computer apparatus as well as the computer apparatus is in a power-saving or sleeping mode at this time, the user only needs to operate a peripheral apparatus of a computer system (such as, pressing any key of a keyboard, and moving a mouse), so as to enable the computer system to be restored to an original normal operating mode, and the above-mentioned function is referred to as a peripheral wake-up function herein. In other words, the peripheral wake-up function refers to using a peripheral device (such as a keyboard and a mouse) of the computer system to enable the computer system to be restored to the normal operating state from the power-saving or sleeping state. Moreover, the peripheral wake-up function generally has been implemented in the CPU of the X86 architecture and the chip set thereof.

However, although having a power-saving or sleeping mode, a CPU implemented by using Advanced Reduced Instruction-Set Computer (RISC) Machine (ARM) architecture still does not have a similar peripheral wake-up function being built in. Therefore, if a computer apparatus is implemented by using the ARM architecture, the peripheral wake-up function still need to be employed.

### SUMMARY OF THE INVENTION

An embodiment of the disclosure provides a computer apparatus comprising a peripheral device, a hub unit and a control unit. The peripheral device is configured to generate an input signal. The hub unit is coupled to the peripheral device. When the computer apparatus is in a power-saving state, the hub unit is configured to receive the input signal to generate a wake-up event (WUE). The control unit is coupled to the hub unit. When the computer apparatus is in the power-saving state, the control unit is configured to detect whether the WUE is generated, so as to wake up the computer apparatus, so that the computer apparatus is returned to a normal operating state from the power-saving state.

In one embodiment of the disclosure, the computer apparatus further comprises: a central processing unit (CPU) configured to operate in the normal operating state of the computer apparatus, and to stop operating in the power-saving state of the computer apparatus. When the computer apparatus is returned to the normal operating state, the control unit is configured to enable the CPU to restore operating.

In one embodiment of the disclosure, the hub unit and the control unit are configured to keep operating in the power-saving state of the computer apparatus.

In one embodiment of the disclosure, the CPU is implemented by using Advanced Reduced Instruction-Set Computer (RISC) Machine (ARM) architecture.

In one embodiment of the disclosure, the hub unit is a Universal Serial Bus (USB) hub control chip; the control unit is a microprocessor or an embedded chip.

In one embodiment of the disclosure, the peripheral device is connected to the hub unit from outside the computer apparatus through a USB connection port, or, the peripheral device is disposed inside the computer apparatus, and is connected to the hub unit based on a USB protocol.

Another embodiment of the disclosure provides a wake-up method of a computer apparatus. The steps are as followed. In a power-saving state of the computer apparatus, an input signal of a peripheral device is received by a hub unit in the computer apparatus to generate a wake-up event (WUE). Whether the WUE is generated is detected. When the WUE is generated, the computer apparatus is woken up so that the computer apparatus is returned to a normal operating state from the power-saving state.

In one embodiment of the disclosure, the wake-up method further comprises a step of: enabling the hub unit to keep operating in the power-saving state of the computer apparatus.

In one embodiment of the disclosure, the computer apparatus further comprises a central processing unit (CPU) configured to operate in the normal operating state of the computer apparatus, and configured to stop operating in the power-saving state of the computer apparatus, and wherein when the computer apparatus is returned to the normal operating state, the CPU is enabled to restore operating.

In one embodiment of the disclosure, the CPU is implemented by using Advanced Reduced Instruction-Set Computer (RISC) Machine (ARM) architecture.

### BRIEF DESCRIPTION OF THE DRAWINGS

The disclosure will become more fully understood from the detailed description given herein below for illustration only, thus does not limit the disclosure, wherein:

FIG. 1 is a block diagram of a computer apparatus according to an embodiment of the disclosure; and

FIG. 2 is a block diagram of a wake-up method of a computer apparatus according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

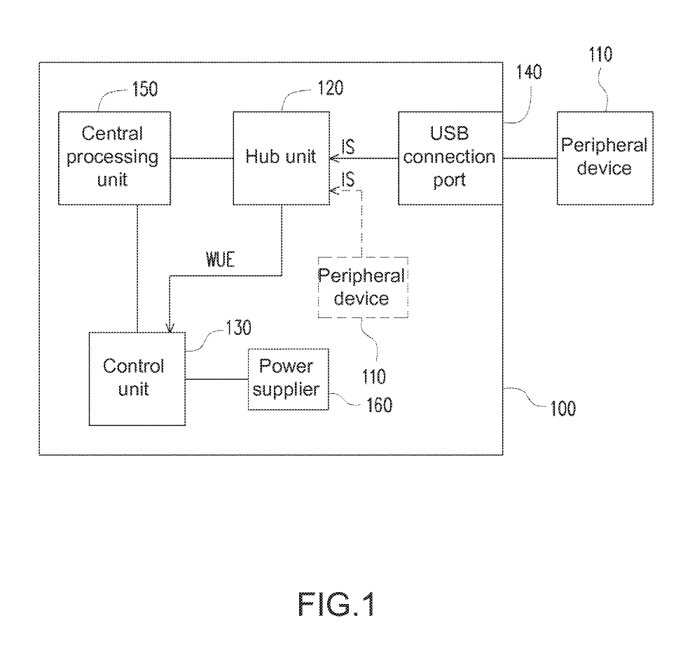

FIG. 1 is a block diagram of a computer apparatus 100 according to an embodiment of the disclosure. Referring to FIG. 1, the computer apparatus 100 comprises a peripheral device 110, a hub unit 120, and a control unit 130. In this embodiment, the computer apparatus 100 further comprises a Universal Serial Bus (USB) connection port 140, a central processing unit (CPU) 150, and a power supplier 160, which are described in detail one by one in the following description.

The computer apparatus 100 is, for example, an integral computer (namely, all-in-one computer), a barebone computer, or a portable computer, and comprises the CPU 150. Typically, this embodiment is implemented by the CPU 150 and the computer apparatus 100 of the ARM architecture. For example, the embodiment of the disclosure adopts PXA2128 model as an implementation of the CPU 150 adopting Advanced Reduced Instruction-Set Computer (RISC) Machine (ARM) architecture. The CPU 150 in configured to operate due to normal power supply in the normal operating state of the computer apparatus 100, and to stop operating due to interruption of the power supply in the power-saving state of the computer apparatus 100. The power supplier 160 is configured to supply power for various elements in the computer apparatus 100.

In the conventional technology, the CPU is mainly of X86 architecture, if the user intends to wake up the computer apparatus from the power-saving state (for example, a standby state) to the normal operating state, the user generally receives a wake-up signal through a peripheral device (for example, a mouse and a keyboard) which is connected to a human interface device (HID) connection interface (for example, a Personal System/2 (PS/2) interface) or a data transmission connection port (for example, a USB connection port), thereby waking up the computer apparatus.

On the other hand, the CPU 150 and the computer apparatus 100 adopting the ARM architecture are gradually popular in manufacturers, and are gradually applied in portable devices, such as a tablet computer and a smartphone. Therefore, many manufactures intend to additionally design and dispose peripheral devices, such as a physical keyboard and a mouse, for the computer apparatus 100 of the ARM architecture, so that the portable device is capable of achieving the effect similar to a notebook computer.

In order that the computer apparatus 100 of the ARM architecture is also capable of having the peripheral wake-up function, the embodiment of the disclosure uses the hub unit 120 and the control unit 130 to implement the peripheral wake-up function, and therefore the CPU 150 does not need to implement the wake-up function. Therefore, the embodiment of the disclosure is also applicable to a CPU and a computer apparatus adopting the X86 architecture, which is not limited to the disclosure. However, generally speaking, the CPU adopting the X86 architecture and the chip set thereof already have the peripheral wake-up function as a built-in function.

The peripheral device 110 is, for example, an external mouse or a keyboard connected to the hub unit 120 from outside the computer apparatus 100 through the USB connection port 140. In this and some other embodiments, the peripheral device 110 is also an information input device, such as a touch panel, a keyboard and a mouse (as shown by dash lines of FIG. 1), disposed inside the computer apparatus and connected to the hub unit 120 based on the USB protocol or related HID protocol.

In this and other embodiments, the hub unit 120 is directly coupled to the peripheral device 110 through a corresponding protocol, or is indirectly coupled to the peripheral device 110 through the USB connection port 140, so as to receive the input signal transmitted from the peripheral device 110, and integrates the input signal and provides the input signal to the CPU 150. Most of the CPUs 150 implemented by using the ARM architecture are only capable of supporting or controlling a few (for example, one or two) USB connection ports, so that the number of pins of the CPU 150 is reduced to decrease the area of the chip. Therefore, when the USB connection ports of the current computer apparatus 100 implemented by using the ARM architecture need to be expanded, the hub unit 120 (for example, a USB hub control chip) is additionally disposed in a motherboard of the computer apparatus 100. In other words, by means of the hub unit 120, in the computer apparatus 100, the CPU 150, originally supporting a few USB connection ports, is expanded to support and to correspond the number of USB connection ports that is capable of being supported by a USB hub chip. In the embodiment of the disclosure, a USB hub control chip of GL850 model is taken as an example.

In this and some other embodiments, the control unit 130 is implemented by using a microprocessor or an embedded chip having lower power consumption as compared with the CPU 150. In this embodiment, the control unit 130 is configured to keep being powered in the power-saving state (for example, the standby state) of the computer apparatus 100, so as to continuously detect related statuses of the computer apparatus 100 and to respond accordingly.

Therefore, when the computer apparatus 100 enters the power-saving state (standby state) from the normal operating state, the CPU 150 and most elements in the computer apparatus 100 stop operating, for example, the CPU 150. On the other hand, in this embodiment of the disclosure, power supply is continuously provided for the hub unit 120 and the control unit 130 to keep the hub unit 120 and the control unit 130 operating continuously. In the power-saving state (standby state) of the computer apparatus 100, the hub unit 120 receives an input signal IS provided by the peripheral device 110. When receiving the input signal IS, the hub unit 120 provides a wake-up event (WUE) to the control unit 130. For example, when the user controls the peripheral device 110 to enable the peripheral device 110 to transmit the input signal (for example, pressing any key of the keyboard, and moving the mouse) in the power-saving state (standby state) of the computer apparatus 100, the hub unit 120 accordingly provides the WUE to the control unit 130.

In this and some other embodiments, the WUE is that the hub unit 120 transmits a wake-up signal of a specific format to the control unit 130, so that the control unit 130 determines that the peripheral device 110 is being used by the user, or the hub unit 120 notifies the control unit 130 by applying other methods, which is not limited to the disclosure.

The control unit 130, in the power-saving state of the computer apparatus 100, is configured to detect whether the WUE is generated. When it is detected that the WUE has been generated, the control unit 130 notifies the CPU 150 and the power supplier 160, so that the power supplier 160 supplies power to the CPU 150 and corresponding elements to restore operating, thereby waking up the computer apparatus 100 as well as enabling the computer apparatus to return to the normal operating state from the power-saving state (standby state). Therefore, the embodiment of the disclosure implements the peripheral wake-up function by using the hub unit 120 and the control unit 130.

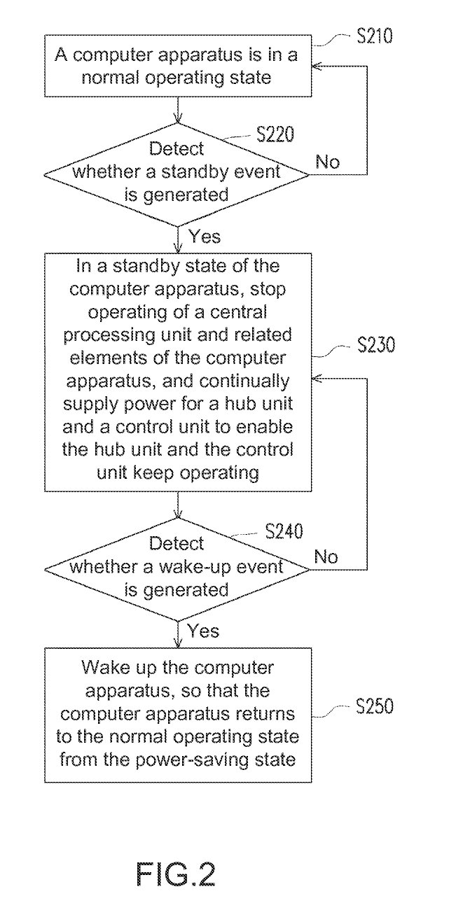

An embodiment of the disclosure is also implemented from another view of point. FIG. 2 is a block diagram of a wake-up method of the computer apparatus 100 according to an embodiment of the disclosure. Referring to FIG. 1 and FIG. 2 together, in step S210, the computer apparatus 100 is started and in a normal operating state. In step S220, the CPU 150 of the computer apparatus 100 detects and determines whether a standby event is generated. In this and other embodiments, the standby event means that after the computer apparatus 100 is not being used for a predetermined period of time, the CPU 150 automatically determines the computer apparatus 100 needs to enter the power-saving state (standby state), or that the user presses a specific key to enable the computer apparatus 100 to directly enter the power-saving state (standby state).

When in step S220, it is determined that no standby event is generated, the computer apparatus 100 is always in the normal operating mode. Otherwise, when in step S220, it is determined that a standby event is generated, the procedure proceeds to step S230, in which in the power-saving mode (standby mode) of the computer apparatus, power supply for the CPU 150 and related elements of the computer apparatus 100 is stopped to enable the CPU 150 and related elements to stop operating, and power supply for the hub unit 120 and the control unit 130 is provided continuously to keep them operating.

In step S240, the control unit 130 detects whether the WUE of the hub unit 120 is generated. Typically, when receiving the input signal of the peripheral device 110, the hub unit 120, disposed in the computer apparatus 100, generates the WUE as well as the control unit 130 is capable of detecting the generated WUE at this time. When the generated WUE is detected, the procedure proceeds from step S240 to step S250, in which the control unit 130 notifies the CPU 150 and the power supplier 160, so that the power supplier 160 supplies power to the CPU 150 and the related elements to enable them to restore operating, thereby waking up the computer apparatus 100, and enabling the computer apparatus to return to the normal operating state from the power-saving state (standby state). As for other related teachings of the embodiment of the disclosure, reference is made to the above embodiment, and the repeated parts are note described herein.

In view of the above, embodiments of the disclosure utilize the hub unit in the computer apparatus to continuously detect whether the peripheral device generates the input signal in the power-saving mode. After receiving the input signal, the hub unit notifies the control unit, so that the control unit returns the computer apparatus to the normal operating state from the original power-saving state. In other words, the computer apparatus in this disclosure uses the hub unit to implement the peripheral wake-up function, without the need of implementing through the CPU. Therefore, the computer apparatus of the ARM architecture is capable of implementing the peripheral wake-up function by using the original hardware architecture, so that the user obtains a better use experience.

What is claimed is:

1. A computer apparatus, comprising:
a peripheral device configured to generate an input signal;
a hub unit coupled to the peripheral device, and wherein when the computer apparatus is in a power-saving state, the hub unit is configured to receive the input signal to generate a wake-up event (WUE); and
a control unit coupled to the hub unit, and wherein when the computer apparatus is in the power-saving state, the control unit is configured to detect whether the WUE is generated, so as to wake up the computer apparatus, so that the computer apparatus is returned to a normal operating state from the power-saving state.

2. The computer apparatus according to claim 1, further comprising:
a central processing unit (CPU) configured to operate in the normal operating state of the computer apparatus, and to stop operating in the power-saving state of the computer apparatus, and
when the computer apparatus is returned to the normal operating state, the control unit is configured to enable the CPU to restore operating.

3. The computer apparatus according to claim 1, wherein the hub unit and the control unit are configured to keep operating in the power-saving state of the computer apparatus.

4. The computer apparatus according to claim 1, wherein the CPU is implemented by using Advanced Reduced Instruction-Set Computer (RISC) Machine (ARM) architecture.

5. The computer apparatus according to claim 1, wherein the hub unit is a Universal Serial Bus (USB) hub control chip; the control unit is a microprocessor or an embedded chip.

6. The computer apparatus according to claim 1, wherein the peripheral device is connected to the hub unit from outside the computer apparatus through a USB connection port, or,
the peripheral device is disposed inside the computer apparatus, and is connected to the hub unit based on a USB protocol.

7. A wake-up method of a computer apparatus, comprising:
in a power-saving state of the computer apparatus, receiving an input signal of a peripheral device by a hub unit disposed in the computer apparatus to generate a wake-up event (WUE);
detecting whether the WUE is generated; and
when the WUE is generated, waking up the computer apparatus so that the computer apparatus is returned to a normal operating state from the power-saving state.

8. The wake-up method according to claim 7, further comprising:
enabling the hub unit to keep operating in the power-saving state of the computer apparatus.

9. The wake-up method according to claim 7, wherein the computer apparatus further comprises a central processing unit (CPU) configured to operate in the normal operating state of the computer apparatus, and configured to stop operating in the power-saving state of the computer apparatus, and wherein when the computer apparatus is returned to the normal operating state, the CPU is enabled to restore operating.

10. The wake-up method according to claim 9, wherein the CPU is implemented by using Advanced Reduced Instruction-Set Computer (RISC) Machine (ARM) architecture.
